(19) United States
(12) Patent Application Publication
(10) Pub. No.: US 2016/0187285 A1
(43) Pub. Date: Jun. 30, 2016

(54) GAS SENSOR ELEMENT AND GAS SENSOR

(71) Applicant: NGK SPARK PLUG CO., LTD., Nagoys-shi (JP)

(72) Inventors: Nobuo FURUTA, Kasugai-shi (JP); Masaki MIZUTANI, Niwa-gun (JP)

(73) Assignee: NGK SPARK PLUG CO., LTD., Nagoya-shi (JP)

(21) Appl. No.: 14/969,267

(22) Filed: Dec. 15, 2015

(30) Foreign Application Priority Data
Dec. 16, 2014 (JP) 2014-253680
Nov. 10, 2015 (JP) 2015-219990

(51) Int. Cl. G01N 27/407

(52) U.S. Cl. CPC G01N 27/4071; G01N 27/4077

(57) ABSTRACT

A plate-like gas sensor element extending in a longitudinal direction includes a plate-like composite ceramic layer which has an insulation portion having a through hole formed at a longitudinally forward end side and a solid electrolyte portion disposed in the through hole; an electrode portion disposed in contact with the solid electrolyte portion on a one-main-surface side of the composite ceramic layer; and a lead portion which is in contact with only the insulation portion on the one-main-surface side of the composite ceramic layer, whose forward end is recessed from the through hole toward a rear end side with respect to the longitudinal direction, and which is electrically connected to the electrode portion and extends longitudinally rearward. A rear end portion of the electrode portion overlaps with a forward end portion of the lead portion on the insulation portion on the one-main-surface side of the composite ceramic layer.

### TECHNICAL FIELD

The present invention relates to a gas sensor element and a gas sensor.

### BACKGROUND ART

A gas sensor is used for controlling combustion of an internal combustion engine. The gas sensor includes a gas sensor element for outputting a detection signal indicative of the concentration of a particular component (e.g., oxygen) of exhaust gas emitted from the internal combustion engine. For example, the gas sensor element described in Patent Document 1 includes a plate-like solid electrolyte layer extending in a longitudinal direction, an electrode portion provided on that portion of the solid electrolyte layer which is located toward the forward end with respect to the longitudinal direction, and a lead portion electrically connected to the electrode portion and extending rearward along the longitudinal direction. The lead portion is provided on the solid electrolyte layer with an insulation layer intervening therebetween.

### PRIOR ART DOCUMENT

### Patent Document

[Patent Document 1] Japanese Patent Application Laid-Open (kokai) No. 2012-177638

### SUMMARY OF THE INVENTION

### Problem to be Solved by the Invention

In the gas sensor element described in Patent Document 1, since the lead portion is provided on the solid electrolyte layer with the insulation layer intervening therebetween, the electrode portion is connected to the lead portion through an intermediate portion provided for riding up to the insulation layer. Thus, the intermediate portion is formed thicker than is, for example, a forward end portion of the electrode portion. The thick intermediate portion may contract greatly in a firing step in the course of manufacture of the gas sensor element. As a result of such contraction, the intermediate portion may come apart from the solid electrolyte layer, potentially resulting in occurrence of cracking or breaking in the electrode portion or the lead portion. Thus, regarding the gas sensor element or the gas sensor, demand has been rising for a technique for restraining the separation of the electrode portion and the lead portion from a ceramic layer.

Such a problem is not limited to gas sensors for internal combustion engines, but is common among gas sensor elements or gas sensors which can detect the concentration of a particular gas.

### Means for Solving the Problem

The present invention has been conceived to solve the above problem and can be embodied in the following modes.

(1) A mode of the present invention provides a gas sensor element having a plate-like form and extending in a longitudinal direction. The gas sensor element comprises a plate-like composite ceramic layer which has an insulation portion having a through hole formed at a forward end side with respect to the longitudinal direction and a solid electrolyte portion disposed in the through hole; an electrode portion disposed on a one-main-surface side of the composite ceramic layer to be in contact with the solid electrolyte portion; and a lead portion which is in contact with only the insulation portion on the one-main-surface side of the composite ceramic layer, whose forward end is recessed from the through hole toward a rear end side with respect to the longitudinal direction, and which is electrically connected to the electrode portion and extends toward the rear end side along the longitudinal direction. In the gas sensor element, a rear end portion of the electrode portion overlaps with a forward end portion of the lead portion on the insulation portion on the one-main-surface side of the composite ceramic layer.

In the gas sensor element of the above mode, the composite ceramic layer is configured such that the solid electrolyte portion is disposed in the through hole formed in the insulation portion, and the lead portion is recessed from the through hole and disposed on only the insulation portion without being in contact with the solid electrolyte portion; thus, there is no need to provide an insulation layer between the lead portion and the insulation portion. Accordingly, an overlap portion (connection portion) between the lead portion and the electrode portion can be reduced in thickness. Thus, in a firing step in the course of manufacture of the gas sensor element, there is restrained a great contraction of the connection portion between the lead portion and the electrode portion; therefore, there can be restrained the separation of the electrode portion and the lead portion from the composite ceramic layer. As a result, the occurrence of cracking or breaking in the electrode portion and the lead portion is restrained.

(2) The gas sensor element of the above mode may be configured as follows: the rear end portion of the electrode portion overlies the forward end portion of the lead portion, and the rear end portion of the electrode portion is greater in thickness than the forward end portion of the electrode portion disposed on the solid electrolyte portion, only on the insulation portion on the one-main-surface side of the composite ceramic layer.

In the case where the rear end portion of the electrode portion overlies the forward end portion of the lead portion, the rear end portion of the electrode portion includes a portion greater in thickness than the forward end portion of the electrode portion. If the portion having an increased thickness is disposed on the solid electrolyte portion, the difference in electrode thickness may cause variation in accuracy in gas detection. By contrast, in the gas sensor element of the above mode, since the portion having an increased thickness in the rear end portion of the electrode portion is not disposed on the solid electrolyte portion, variation in accuracy in gas detection caused by the difference in electrode thickness can be reduced.

(3) The gas sensor element of the above mode may further comprise a reference conductor layer which is disposed on an other-main-surface side of the composite ceramic layer and has a reference electrode portion disposed in contact with the solid electrolyte portion, and a reference lead portion electrically connected to the reference electrode portion and extending toward the rear end side along the longitudinal direction, and a ceramic layer disposed on the composite ceramic layer through the reference conductor layer, and may be configured as follows: the reference electrode portion serves as an oxygen reference electrode as a result of application of fixed current between the electrode portion and the reference electrode portion, and only the rear end portion of the electrode portion overlaps with the forward end portion of the lead portion.

In the gas sensor element in which, on the other-main-surface side of the composite ceramic layer, the reference electrode portion and the reference lead portion are disposed in such a manner as to be sandwiched between the composite ceramic layer and the ceramic layer, and the reference electrode portion is used as an oxygen reference electrode, the reference electrode portion and the reference lead portion must be formed of a porous material. Thus, the gas sensor element can be formed such that the reference electrode portion and the reference lead portion are readily formed integral with each other rather than being formed separately from each other. Therefore, in such a gas sensor element, preferably, only the electrode portion and the lead portion are formed in an overlapping manner.

The present invention can be embodied in various forms other than the gas sensor element. For example, the present invention can be embodied in a gas sensor using a gas sensor element, and a method of manufacturing a gas sensor element or a gas sensor.

### BRIEF DESCRIPTION OF THE DRAWINGS

FIG. 1 Longitudinal sectional view of a gas sensor taken along an axial line.

FIG. 2 Exploded perspective view of a gas sensor element.

FIG. 3 Plan view of a forward end portion of a composite ceramic layer.

FIG. 4 Sectional view taken along line 4-4 of FIG. 3.

FIG. 5 Flowchart showing a method of manufacturing the gas sensor element.

FIG. 6 Explanatory view showing the constitution of a second conductor layer in a second embodiment of the present invention.

### MODES FOR CARRYING OUT THE INVENTION

### A. First Embodiment

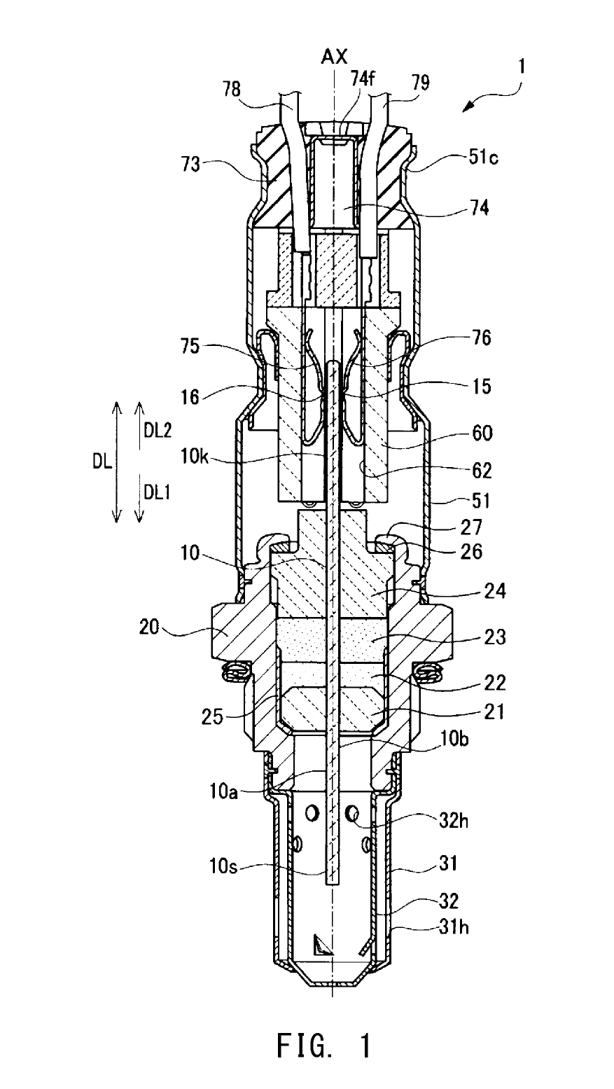

FIG. 1 is a longitudinal sectional view, taken along an axial line AX, of a gas sensor 1 according to a first embodiment of the present invention. The gas sensor 1 is, for example, an oxygen sensor attached for use to an exhaust pipe of an internal combustion engine. In the following description, the lower side of the gas sensor 1 in FIG. 1 is referred to as a forward end side DL1, and the upper side is referred to as a rear end side DL2.

The gas sensor 1 includes a gas sensor element 10 and a metallic shell 20. The gas sensor element 10 is a plate-like element extending in a longitudinal direction DL and is configured to detect the oxygen concentration of exhaust gas, which is gas to be measured. The gas sensor element 10 is disposed in the gas sensor 1 in such a manner that its center line along the longitudinal direction DL coincides with the axial line AX.

The metallic shell 20 is a tubular metallic member for holding the gas sensor element 10 therein. The metallic shell 20 holds the gas sensor element 10 in such a manner that a forward end portion 10s of the gas sensor element 10 protrudes forward therefrom, while a rear end portion 10k of the gas sensor element 10 protrudes rearward therefrom. An outer protector 31 made of metal and an inner protector 32 made of metal are disposed at the forward end side of the metallic shell 20 and cover the forward end portion 10s of the gas sensor element 10. The outer protector 31 and the inner protector 32 have a plurality of gas introduction holes 31h and 32h, respectively. Gas to be measured is introduced from outside the outer protector 31 into a surrounding space around the forward end portion 10s of the gas sensor element 10 disposed inside the inner protector 32.

In the interior of the metallic shell 20, an annular ceramic holder 21, a powder filler layers 22 and 23 (hereinafter, may also be called the talc rings 22 and 23), and a ceramic sleeve 24 are disposed rearward in this order from the forward end side in such a manner as to parametrically surround the gas sensor element 10. A metallic holder 25 is disposed around the circumferences of the ceramic holder 21 and the talc ring 22. A crimp packing 26 is disposed at the rear end side of the ceramic sleeve 24. A rear end portion 27 of the metallic shell 20 is crimped through the crimp packing 26 in such a manner as to press forward the ceramic sleeve 24.

Meanwhile, an outer tube 51 is disposed on the rear end side of the metallic shell 20 in such a manner as to surround the rear end portion 10k of the gas sensor element 10. Furthermore, a separator 60 is disposed inside the outer tube 51. The separator 60 parametrically surrounds the rear end portion 10k of the gas sensor element 10 and holds four terminal members 75, 75, 76, and 76 (FIG. 1 shows only two of them) attached to distal ends of four lead wires 78, 78, 79, and 79 (FIG. 1 shows only two of them), respectively, in such a manner that the terminal members are separated from one another. The separator 60 has an insertion hole 62 extending therethrough along the axial line AX. The rear end portion 10k of the gas sensor element 10 is inserted into the insertion hole 62. The four terminal members, 75, 75, 76, and 76 are disposed within the insertion hole 62 in such a manner as to be separated from one another and are elastically in contact with pads 14 to 17, which will be described herein later, of the gas sensor element 10 to thereby be electrically connected to the pads.

In the gas sensor 1 of the present embodiment, a metallic member 74 covered with a water-repellent gas-permeable filter 74f is fitted into a grommet 73 plugged into a rear end opening portion 51c of the outer tube 51. Thus, the gas sensor 1 can introduce the atmosphere existing therearound into the outer tube 51 through the filter 74f and up to a surrounding space around the rear end portion 10k of the gas sensor element 10.

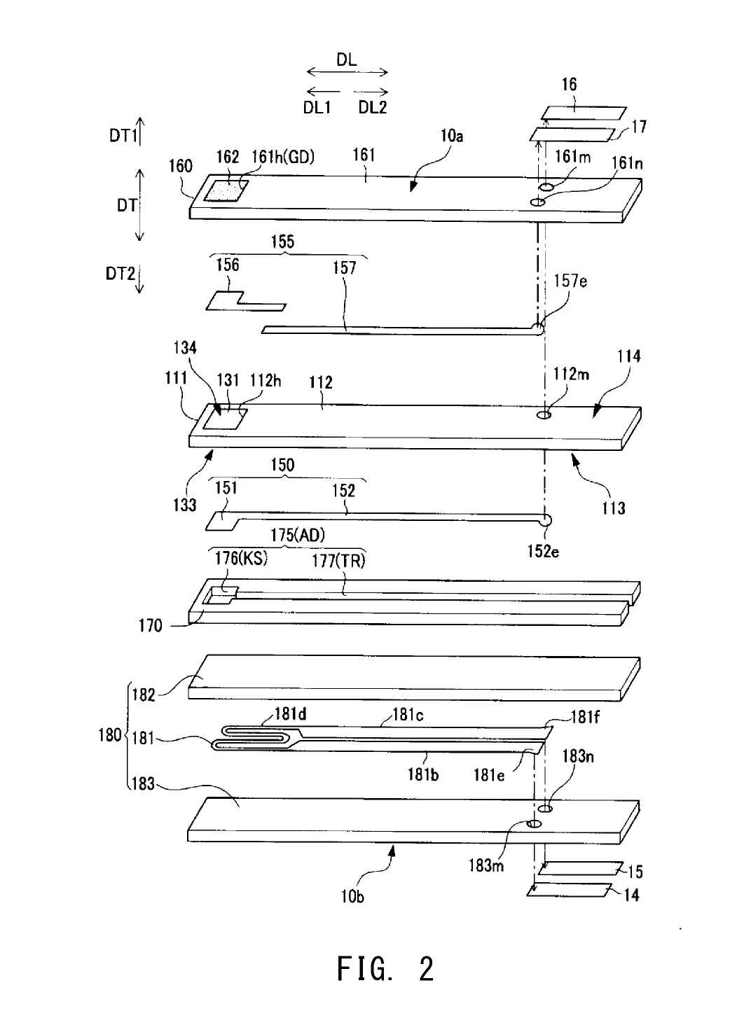

FIG. 2 is an exploded perspective view of the gas sensor element 10. In FIG. 2, the left side corresponds to the forward end side DL1 of the gas sensor 1, and the right side corresponds to the rear end side DL2.

The gas sensor element 10 has two sensor pads 16 and 17 formed on a first element main surface 10a facing one side DT1 with respect to a thickness direction DT, at the rear end portion 10k (see FIG. 1). The sensor pad 16 is electrically connected to a first conductor layer 150 within the gas sensor element 10, and the sensor pad 17 is electrically connected to a second conductor layer 155 within the gas sensor element 10. Also, the gas sensor element 10 has two heater pads 14 and 15 formed on a second element main surface 10b facing the other side DT2 with respect to the thickness direction DT, at the rear end portion 10k. The heater pads 14 and 15 are electrically connected to a heater pattern 181, which will be described herein later, within the gas sensor element 10.

The gas sensor element 10 is composed of a plurality of ceramic layers and conductor layers laminated together in the thickness direction DT. Specifically, as shown in FIG. 2, the gas sensor element 10 has a composite ceramic layer 111 including an insulation portion 112 and a solid electrolyte portion 131, and, on the thickness-direction one side DT1 of the composite ceramic layer 111, the second conductor layer 155 and a protection layer 160 are laminated in this order. Also, on the thickness-direction other side DT2 of the composite ceramic layer 111, the first conductor layer 150, an introduction path formation layer 170, and a heater layer 180 are laminated in this order.

The composite ceramic layer 111 includes the insulation portion 112 and the solid electrolyte portion 131. The insulation portion 112 is formed of alumina, assumes a rectangular plate-like form, and has a through hole 112h which extends therethrough in the thickness direction DT and has a rectangular shape as viewed in plane. The solid electrolyte portion 131 is formed of oxygen ion conductive zirconia ceramic, assumes a plate-like form, and is disposed in the through hole 112h of the insulation portion 112. The insulation portion 112 has a first insulation main surface 113 which faces the thickness-direction other side DT2, and a second insulation main surface 114 which faces the thickness-direction one side DT1. The solid electrolyte portion 131 has a first electrolyte main surface 133 facing the thickness-direction other side DT2, and a second electrolyte main surface 134 which faces the thickness-direction one side DT1.

The first conductor layer 150 is composed of a rectangular first electrode portion 151 formed on the first electrolyte main surface 133 of the solid electrolyte portion 131 in such a manner as to be recessed inward from the through hole 112h, and a strip-like first lead portion 152 extending from the first electrode portion 151 toward the longitudinally rear end side DL2. That is, the first conductor layer 150 extends in a continuous manner on the first electrolyte main surface 133 as well as on the first insulation main surface 113.

The second conductor layer 155 is composed of a second electrode portion 156 which has a substantially rectangular portion formed on the second electrolyte main surface 134 of the solid electrolyte portion 131 in such a manner as to be recessed inward from the through hole 112h and which also has a strip-like portion extending from the substantially rectangular portion toward the longitudinally rear end side DL2, and a strip-like second lead portion 157 extending from the second electrode portion 156 toward the longitudinally rear end side DL2. That is, the second conductor layer 155 extends in a continuous manner on the second electrolyte main surface 134 as well as on the second insulation main surface 114. The detailed constitution of the second conductor layer 155 will be described herein later.

The protection layer 160 is laminated on the thickness-direction one side DT1 of the composite ceramic layer 111 and covers the second conductor layer 155. The protection layer 160 includes a porous portion 162 and a protection portion 161. The porous portion 162 is formed of a porous ceramic disposed on the second electrode portion 156 and on the solid electrolyte portion 131 of the composite ceramic layer 111. The protection portion 161 is formed of a dense ceramic which overlies the insulation portion 112 of the composite ceramic layer 111 to protect the same and in which a through hole 161h is formed to accommodate the porous portion 162 therein in a surrounding manner. The through hole 161h serves as a gas introduction path GD for introducing ambient gas to be measured to the second electrode portion 156.

The aforementioned sensor pads 16 and 17 are provided on the protection portion 161. The sensor pad 16 electrically communicates with an end portion 152e of the first conductor layer 150 located at the rear end side DL2 through through holes 112m and 161m. The sensor pad 17 electrically communicates with an end portion 157e of the second conductor layer 155 located at the rear end side DL2 through a through hole 161n.

The introduction path formation layer 170 is formed of a dense ceramic and has an introduction groove 175 extending therethrough in the thickness direction DT. The introduction groove 175 is surrounded by not only the introduction path formation layer 170 but also the composite ceramic layer 111 and the heater layer 180 (insulation layer 182), thereby forming an atmosphere introduction path AD for introducing the atmosphere to the first electrode portion 151. More specifically, the introduction groove 175 is composed of a reference chamber groove 176 having a rectangular shape as viewed in plane and an atmosphere flow groove 177 which is smaller in width than the reference chamber groove 176, extends toward the rear end side DL2 from the reference chamber groove 176, and opens at the rear end (right end in FIG. 2) of the introduction path formation layer 170. The reference chamber groove 176 is surrounded by not only the introduction path formation layer 170 but also the solid electrolyte portion 131 of the composite ceramic layer 111 and the heater layer 180, thereby forming a reference chamber KS. Also, the atmosphere flow groove 177 is surrounded by not only the introduction path formation layer 170 but also the insulation portion 112 of the composite ceramic layer 111 and the heater layer 180, thereby forming an atmosphere flow path TR. Notably, the first electrode portion 151 formed on the solid electrolyte portion 131 is exposed to the reference chamber KS.

The heater layer 180 includes two plate-like insulation layers 182 and 183 formed of alumina and the heater pattern 181 embedded therebetween. The heater pattern 181 is composed of a meandering heat-generating portion 181d, and a first lead portion 181b and a second lead portion 181c connected to the respective opposite ends of the heat-generating portion 181d and extending rectilinearly. An end portion 181e of the first lead portion 181b located at the rear end side DL2 electrically communicates with the heater pad 14 through a through hole 183m. An end portion 181f of the second lead portion 181c located at the rear end side DL2 electrically communicates with the heater pad 15 through a through hole 183n.

In the gas sensor element 10 according to the present embodiment, the atmosphere around the rear end portion 10k of the gas sensor element 10 reaches the first electrode portion 151 through the aforementioned atmosphere introduction path AD. Meanwhile, gas to be measured around the forward end portion 10s of the gas sensor element 10 reaches the second electrode portion 156 through the porous portion 162 disposed in the through hole 161h of the protection layer 160. Since the solid electrolyte portion 131 is disposed between the first electrode portion 151 and the second electrode portion 156, in the case where the atmosphere in contact with the first electrode portion 151 and gas to be measured in contact with the second electrode portion 156 differ in oxygen concentration, the first electrode portion 151, the solid electrolyte portion 131, and the second electrode portion 156 constitute an oxygen concentration cell, and an electrical potential difference is generated between the first electrode portion 151 and the second electrode portion 156. By use of the gas sensor 1 of the present embodiment, a signal indicative of the electrical potential difference is obtained through the two lead wires 78 which electrically communicate with the sensor pads 16 and 17, whereby the oxygen concentration of gas to be measured can be detected. In measuring the oxygen concentration, current is applied to the heater pattern 181 through the two lead wires 79 which electrically communicate with the heater pads 14 and 15 so that the heater pattern 181 generates heat, thereby activating the solid electrolyte portion 131 through application of heat.

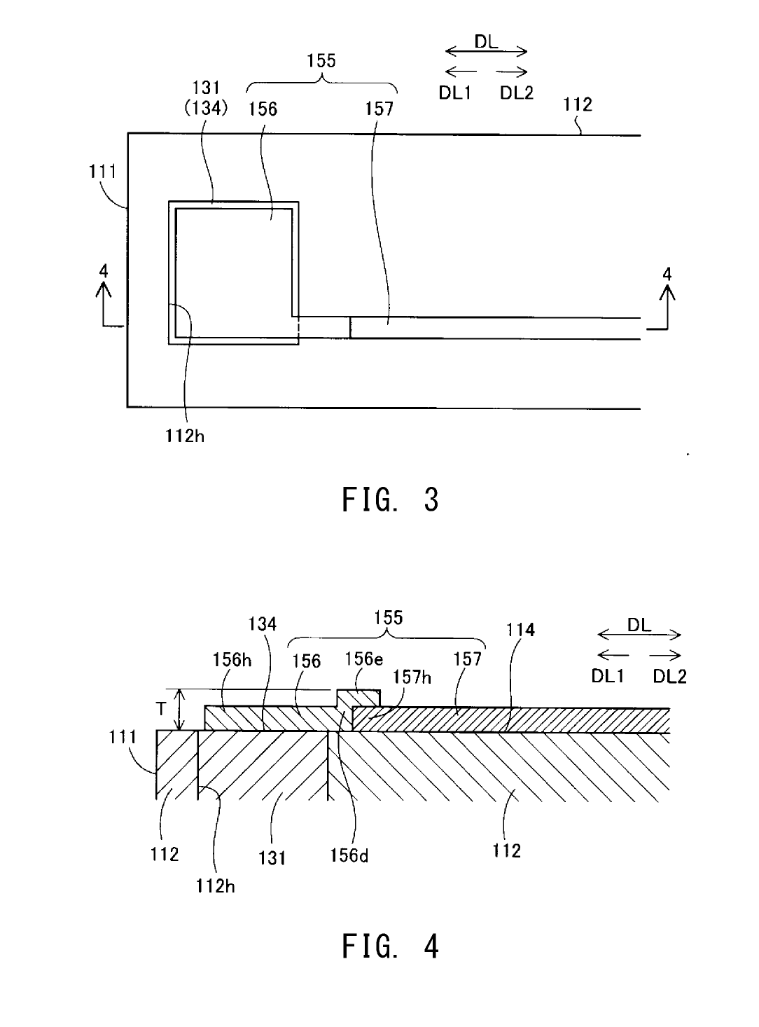

FIG. 3 is a plan view showing an end portion of the composite ceramic layer 111 at the forward end side DL1. As mentioned above, the second conductor layer 155 is composed of the strip-like second lead portion 157 and the second electrode portion 156 which has a substantially rectangular portion formed in such a manner as to be recessed inward from the through hole 112h and to cover a portion of the second electrolyte main surface 134 of the solid electrolyte portion 131 and which also has a strip-like portion extending from the substantially rectangular portion toward the longitudinally rear end side DL2. The second electrode portion 156 and the second lead portion 157 are formed of different materials. Specifically, the second electrode portion 156 is formed of an electrically conductive porous material in order to introduce gas to be measured into the interior thereof. By contrast, in order to reduce electric resistance, the second lead portion 157 is formed of an electrically conductive material higher in density than the second electrode portion 156. The difference in electric resistivity (specific resistance) between the second lead portion 157 and the second electrode portion 156 is, for example, 10 μΩ·cm or greater, and the second lead portion 157 is lower in electric resistivity than the second electrode portion 156. The through holes, including the through hole 161n to which the rear end portion 157e of the second lead portion 157 is connected, are filled with the same material as that of the second lead portion 157.

FIG. 4 is a sectional view taken along line 4-4 of FIG. 3. The second lead portion 157 has a substantially fixed thickness and is in contact with only the insulation portion 112 on the second insulation main surface 114 side of the composite ceramic layer 111. The second lead portion 157 is disposed such that its forward end is recessed toward the longitudinally rear end side DL2 from the through hole 112h provided in the composite ceramic layer 111 and in such a manner as to extend toward the longitudinally rear end side DL2. Meanwhile, the second electrode portion 156, to which the second lead portion 157 is electrically connected, has substantially the same thickness on the second electrolyte main surface 134 as that of the second lead portion 157. A rear end portion 156e of the second electrode portion 156 is disposed externally of the through hole 112h and extends toward the longitudinally rear end side DL2 in such a manner as to overlap with a forward end portion 157h of the second lead portion 157 on the insulation portion 112 on the second insulation main surface 114 side of the composite ceramic layer 111. In the present embodiment, the rear end portion 156e of the second electrode portion 156 overlies the forward end portion 157h of the second lead portion 157. Only on the insulation portion 112 on the second insulation main surface 114 side of the composite ceramic layer 111, the rear end portion 156e of the second electrode portion 156 is greater in thickness T than a forward end portion 156h of the second electrode portion 156 disposed on the first electrolyte main surface 133 of the solid electrolyte portion 131. That portion of the second electrode portion 156 whose thickness T is increased may hereinafter also be called a stepped portion 156d. Preferably, the forward end of the second lead portion 157 is located on the longitudinally forward end side DL1 with respect to the center of the longitudinal overall length of the gas sensor element 10. Furthermore, preferably, the forward end of the second lead portion 157 is located within a longitudinal region of the gas sensor element 10 where the heat-generating portion 181d of the heater pattern 181 is disposed.

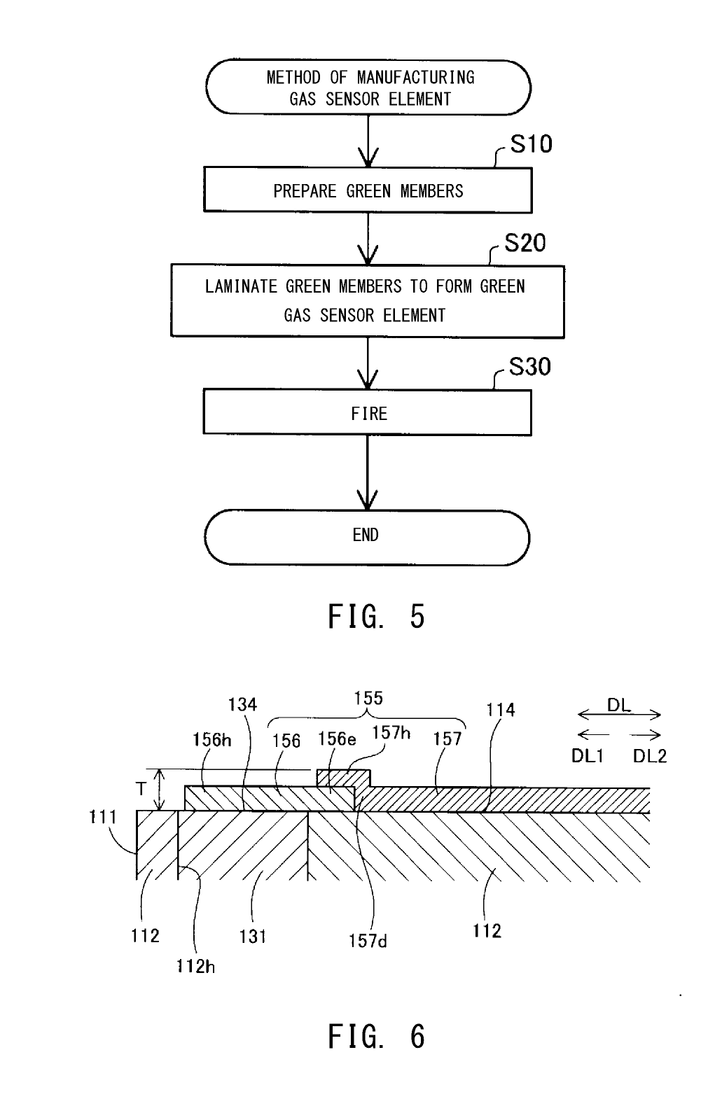

FIG. 5 is a flowchart showing a method of manufacturing the gas sensor element 10. In the following description, for convenience sake, the same reference numerals are assigned to members after firing and to members before firing which correspond to the members after firing. In the method of manufacturing the gas sensor element 10 of the present embodiment, first, green members corresponding to component members of the gas sensor element 10 are prepared (step S10). Specifically, green insulation layers 183 and 182, a green introduction path formation layer 170, a green composite ceramic layer 111, and a green protection layer 160 are prepared.

Of these members, the green composite ceramic layer 111 is manufactured, for example, by the following procedure. First, there are prepared a green insulation-portion sheet (green insulation sheet) and a green electrolyte-portion sheet (green electrolyte sheet) which are formed by a doctor blade process or the like. Next, the through hole 112h is formed in the green insulation-portion sheet by use of a punch, thereby yielding a green insulation portion 112. Subsequently, by use of the punch, a green electrolyte portion 131 is inserted into the through hole 112h of the green insulation portion 112. Specifically, a green electrolyte-portion sheet is placed on the green insulation portion 112; then, by use of the above-mentioned punch, the green electrolyte portion 131 is punched out from the green electrolyte-portion sheet and is then inserted into the through hole 112h of the green insulation portion 112. Then, the green insulation portion 112 having the green electrolyte portion 131 inserted into the through hole 112h thereof is compressed in the thickness direction.

Next, by a screen printing process, a green first conductor layer 150 (a green first electrode portion 151 and a green first lead portion 152) is formed in such a manner as to extend in a continuous manner on a first electrolyte sheet main surface 133 of the green electrolyte portion 131 as well as on a first insulation sheet main surface 113 of the green insulation portion 112. The green first conductor layer 150 (green first lead portion 152) is connected to the through hole 112m which extends through the green insulation portion 112.

Subsequently, by the screen printing process, a green second lead portion 157 is formed on a second insulation sheet main surface 114 of the green insulation portion 112; subsequently, by the screen printing process, a green second electrode portion 156 is formed on a second electrolyte sheet main surface 134 of the green electrolyte portion 131. At this time, screen printing is performed in such a manner that, as shown in FIG. 3, the rear end portion 156e of the green second electrode portion 156 overlies the forward end portion 157h of the green second lead portion 157. By the above-mentioned procedure, the green composite ceramic layer 111 is formed.

Next, as shown in FIG. 2, the green insulation layers 183 and 182, the green introduction path formation layer 170, the green composite ceramic layer 111, and the green protection layer 160 are laminated together in this order, thereby yielding a green gas sensor element 10 (step S20). Before these members are laminated together, a green heater pattern 181 and the through holes 183m and 183n are formed beforehand on and in the green insulation layer 183. Also, a green introduction groove 175 composed of a green reference chamber groove 176 and a green atmosphere flow groove 177 is formed beforehand in the green introduction path formation layer 170. Also, a green porous portion 162 which is to become the porous portion 162 after firing, and a green protection portion 161 which surrounds the green porous portion 162 and is to become the protection portion 161 after firing, are formed beforehand in the green protection layer 160. Also, the through holes 161m and 161n to be connected to the through hole 112m and the green second conductor layer 155, respectively, are formed beforehand in the green protection layer 160 at the rear end side DL2. Notably, green pads which are to become the heater pads 14 and 15 and the sensor pads 16 and 17 are formed beforehand by printing on the green insulation layer 183 and the green protection layer 160, respectively.

After the green gas sensor element 10 is formed, the green gas sensor element 10 is fired by a publicly known method (step S30). By performing the above steps, the gas sensor element 10 is formed.

In the gas sensor element 10 and the gas sensor 1 of the present embodiment described above, the solid electrolyte portion 131 is disposed in the through hole 112h provided in the insulation portion 112, thereby yielding the composite ceramic layer 111. Also, since the second lead portion 157 is disposed on the insulation portion 112 in such a manner that the second lead portion 157 is recessed from the through hole 112h and is thus not in contact with the solid electrolyte portion 131, there is no need to provide an additional insulation layer between the second lead portion 157 and the insulation portion 112. Thus, there can be reduced the thickness T of that rear end portion 156e (stepped portion 156d) of the second electrode portion 156 which is overlapped with the second lead portion 157 (is connected to the second lead portion 157). Accordingly, in the firing step in manufacture of the gas sensor element 10, since the occurrence of a great contraction of the stepped portion 156d is restrained, there can be restrained the separation of the second electrode portion 156 from the composite ceramic layer 111, which could otherwise result from the contraction of the stepped portion 156d. As a result, the generation of cracking or breaking in the second electrode 156 can be restrained.

Also, in the present embodiment, since the stepped portion 156d of the second conductor layer 155 is disposed on the insulation portion 112 and is not disposed on the solid electrolyte portion 131, there can be reduced accuracy variations in gas detection caused by thickness unevenness of the second electrode 156.

Also, in the present embodiment, since the dense second lead portion 157 is disposed only on the insulation portion 112, whereas the porous, coarse second electrode portion 156 is disposed on the solid electrolyte portion 131, gas to be measured can favorably pass through the solid electrolyte portion 131. Thus, the occurrence of blackening in the solid electrolyte portion 131 can be restrained, and embrittlement of the solid electrolyte portion 131 can be restrained.

### B. Second Embodiment

FIG. 6 is an explanatory view showing the constitution of the second conductor layer 155 in a second embodiment of the present invention. In the above-described first embodiment, as shown in FIG. 4, the second conductor layer 155 formed on the composite ceramic layer 111 has a structure in which the rear end portion 156e of the second electrode portion 156 overlies the forward end portion 157h of the second lead portion 157. By contrast, in the second embodiment, as shown in FIG. 6, the second conductor layer 155 has a structure in which the forward end portion 157h of the second lead portion 157 overlies the rear end portion 156e of the second electrode portion 156. Through employment of such a structure, the thickness T of a stepped portion 157d of the second lead portion 157 can be reduced, whereby the separation of the second lead portion 157 from the composite ceramic layer 111 (insulation portion 112) can be restrained. As a result, the generation of cracking or breaking in the second lead portion 157 can be restrained.

### C. Modifications

### <Modification 1>

In the above-described embodiments, the second conductor layer 155 is formed such that the forward end portion 157h of the second lead portion 157 and the rear end portion 156e of the second electrode portion 156 overlap each other. Similarly, the first conductor layer 150 may be formed such that a forward end portion of the first lead portion 152 and a rear end portion of the first electrode portion 151 overlap each other.

### <Modification 2>

The structures of the gas sensor element 10 and the gas sensor 1 are not limited to those shown in FIGS. 1 and 2. For example, the gas sensor element may not have the introduction path formation layer 170.

Specifically, of the insulation layers of the heater layer, the insulation layer on the composite ceramic layer side (the insulation layer corresponds to the ceramic layer in claims) is laminated on the composite ceramic layer through the first conductor layer (corresponding to the reference conductor layer in claims). In such a gas sensor element, by means of fixed current being applied between the second electrode portion and the first electrode portion (corresponding to the reference electrode portion in claims), the first electrode portion functions as an oxygen reference electrode for performing gas detection.

In this case, in order for the first electrode portion to function as an oxygen reference electrode, the first electrode portion and the first lead portion (corresponding to the reference lead portion in claims) must be formed of a porous material. Thus, formation of the gas sensor element is facilitated by integrally forming the first electrode portion and the first lead portion rather than separately forming them. That is, it is preferred that while the second electrode portion and the second lead portion are formed in an overlapping manner as mentioned above, the first electrode portion and the first lead portion be formed integral with each other rather than overlapping each other, since the gas sensor element can be easily formed.

### <Modification 3>

The gas sensor element 10 has a single type of solid electrolyte layer. However, for example, the gas sensor element may have two types of solid electrolyte layers called a pump cell and an electromotive cell.

The present invention is not limited to the above-described embodiments and modifications, but may be embodied in various other forms without departing from the spirit of the invention. For example, in order to solve, partially or entirely, the above-mentioned problem or yield, partially or entirely, the above-mentioned effects, technical features of the embodiments and modifications corresponding to technical features of the modes described in the section “Summary of the Invention” can be replaced or combined as appropriate. Also, the technical feature(s) may be eliminated as appropriate unless the present specification mentions that the technical feature(s) is mandatory.

### DESCRIPTION OF REFERENCE NUMERALS

1: gas sensor
10: gas sensor element
14, 15: heater pad
16, 17: sensor pad
20: metallic shell
31: outer protector
32: inner protector
51: outer tube
60: separator
62: insertion hole
73: grommet
74: metallic member
74f: filter
75, 76: terminal member
78, 79: lead wire
111: composite ceramic layer
112: insulation portion
112h: through hole
112m, 161m, 161n, 183m, 183n: through hole
113: first insulation main surface
114: second insulation main surface
131: solid electrolyte portion
133: first electrolyte main surface
134: second electrolyte main surface
150: first conductor layer
151: first electrode portion
152: first lead portion
155: second conductor layer
156: second electrode portion
157: second lead portion
160: protection layer
161: protection portion
161h: through hole
162: porous portion
170: introduction path formation layer
175: introduction groove
176: reference chamber groove
177: atmosphere flow groove
180: heater layer
181: heater pattern
181b: first lead portion
181c: second lead portion
181d: heat-generating portion
182, 183: insulation layer
GD: gas introduction path
AD: atmosphere introduction path
TR: atmosphere flow path
KS: reference chamber
AX: axial line

1. A gas sensor element having a plate-like form and extending in a longitudinal direction, comprising:
a plate-like composite ceramic layer which has an insulation portion having a through hole formed at a forward end side with respect to the longitudinal direction and a solid electrolyte portion disposed in the through hole;
an electrode portion disposed on a one-main-surface side of the composite ceramic layer to be in contact with the solid electrolyte portion; and
a lead portion which is in contact with only the insulation portion on the one-main-surface side of the composite ceramic layer, whose forward end is recessed from the through hole toward a rear end side with respect to the longitudinal direction, and which is electrically connected to the electrode portion and extends toward the rear end side along the longitudinal direction,
wherein a rear end portion of the electrode portion overlaps with a forward end portion of the lead portion on the insulation portion on the one-main-surface side of the composite ceramic layer.

2. A gas sensor element according to as claimed in claim 1, wherein
the rear end portion of the electrode portion overlies the forward end portion of the lead portion and
the rear end portion of the electrode portion is greater in thickness than the forward end portion of the electrode portion disposed on the solid electrolyte portion, only on the insulation portion on the one-main-surface side of the composite ceramic layer.

3. A gas sensor element as claimed in claim 1, further comprising:
a reference conductor layer which is disposed on an other-main-surface side of the composite ceramic layer and has a reference electrode portion disposed in contact with the solid electrolyte portion, and a reference lead portion electrically connected to the reference electrode portion and extending toward the rear end side along the longitudinal direction and
a ceramic layer disposed on the composite ceramic layer through the reference conductor layer,
wherein the reference electrode portion serves as an oxygen reference electrode as a result of application of fixed current between the electrode portion and the reference electrode portion, and
only the rear end portion of the electrode portion overlaps with the forward end portion of the lead portion.

4. A gas sensor comprising:
a gas sensor element extending along an axial line and
a metallic shell perimetrically surrounding the gas sensor element,
wherein the gas sensor element is a gas sensor element as claimed in claim 1.
